(19) United States
(12) Patent Application Publication
(10) Pub. No.: US 2026/0089521 A1
(43) Pub. Date: Mar. 26, 2026

(54) SYSTEMS AND METHODS FOR BACKHAUL BANDWIDTH AND CORE CAPACITY ESTIMATION FOR DEDICATED NETWORKS

(71) Applicant: VERIZON PATENT AND LICENSING INC., Basking Ridge, NJ (US)

(72) Inventors: Sylvestre DEMONGET, Millburn, NJ (US); Robert WALLEY, Canton, GA (US); Chin CHIU, Allen, TX (US); Alpaslan Gence SAVAS, Summit, NJ (US)

(73) Assignee: VERIZON PATENT AND LICENSING INC., Basking Ridge, NJ (US)

(21) Appl. No.: 18/891,516

(22) Filed: Sep. 20, 2024

(51) Int. Cl. H04W 24/06; H04W 24/02

(52) U.S. Cl. CPC H04W 24/06; H04W 24/02

(57) ABSTRACT

Disclosed are systems and methods that provide a computerized framework for accurately and efficiently estimating the backhaul bandwidth and core capacity, which can be utilized to automatically and dynamically configure and/or curate network configurations and topologies to handle network loads and traffic. The framework can utilize and/or operate RF system simulators to perform the estimation of each sector's delivered UL/DL throughputs, as well as user inputs related to the traffic model, the dedicated network's topology and product specifications related to the processing limits of BBUs and private cores in order to determine network bottlenecks. Such determinations and/or predictions can be leveraged to ensure the allocation of backhaul bandwidth and core capacity, among other network features and/or characteristics, are optimized to achieve overall high throughput and remove traffic bottlenecks.

### BACKGROUND INFORMATION

Backhaul bandwidth generally refers to the link capacity between a wireless base station and the core network, such as the S1-U (LTE/5G NSA) or N3 (5G SA) interfaces. It can greatly influence the overall throughput and performance of a wireless network, as it provides the necessary bandwidth to transmit user data between the edge and the core. Core capacity generally refers to the capacity and processing power of the wireless network's central infrastructure, such as the P-GW (LTE/5G NSA) or UPF (5G SA) gateways, which must be sufficient to handle the aggregated traffic from the wireless backhaul connections.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example network architecture according to some embodiments of the present disclosure;

FIG. 1B is a block diagram illustrating components of an exemplary system according to some embodiments of the present disclosure;

FIG. 2 depicts an example network configuration according to some embodiments of the present disclosure;

FIG. 3 illustrates an exemplary workflow that estimates the backhaul bandwidth, according to some embodiments of the present disclosure;

FIG. 4 illustrates an exemplary workflow that estimates the core capacity, according to some embodiments of the present disclosure;

FIG. 5 illustrates a non-limiting example embodiment of a network architecture according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

Current dedicated wireless network solutions may integrate within a public network (e.g., macro network infrastructure of a mobile network operator (MNO)) by building new dedicated nodes that are accessible to both private and public subscribers via Radio Access Network (RAN) sharing schemes such as the Multi-Operator Core Network (MOCN) feature on the access nodes (eNodeB's and gNodeB's), and by using unlicensed spectrum or licensed spectrum for such nodes. Under such an architecture, public subscribers connected on the dedicated network RAN need to access a wireless service provider's (MNO) public packet core, thus requiring a backhaul link (between the eNodeB/gNodeB and the public core) with sufficient bandwidth. Specifically, the S1-U (LTE) and/or N3 (5G SA) interfaces for user plane traffic need to be dimensioned such that they don't become a performance bottleneck.

However, given conventional mechanisms, there are currently no methods for accurately estimating the required backhaul bandwidth for dedicated networks, as this has non-straightforward dependencies on the traffic models and network topologies seen in such custom-built networks. In addition to the backhaul, other performance-limiting factors in dedicated networks include the baseband units and private core processing limits.

To that end, according to some embodiments, the disclosed systems and methods provide a computerized framework that can accurately and efficiently estimate the backhaul bandwidth and private core capacity, which in turn may allow for automatically configuring and/or curating network elements and topologies to best handle current network loads and traffic. In some embodiments, as discussed herein, the disclosed framework can utilize and/or operate a Radio Frequency (RF) simulator to perform the estimation of each sector's delivered uplink (UL) (or upstream or upload, used interchangeably) and/or downlink (DL) (or downstream or download, used interchangeably) throughputs, as well as user inputs related to the traffic model, the dedicated network's topology (e.g., types of sectors and count thereof, mapping of sectors to different baseband units (BBUs)) and product specifications related to the processing limits of BBUs and private core in order to determine, derive or otherwise predict the aforementioned backhaul bandwidth and private core capacity. Thus, as discussed above, such determinations and/or predictions can be leveraged to ensure the allocation of backhaul bandwidth and private core capacity, among other network features and/or characteristics, are optimized for efficient network configuration and topology management, as well as traffic and throughput management. For example, proportionally sized backhaul links can be configured according to required performance characteristics (e.g., UL/DL throughputs of public subscribers) in a dedicated network integrated within a public (macro) network; similarly, the type and model of a private core can be selected according to required performance characteristics (e.g., UL/DL throughputs of private subscribers) in a dedicated network.

Accordingly, in some embodiments, as discussed herein, the disclosed systems and methods function to estimate the backhaul bandwidth and/or the core capacity for a “dedicated network”, which may consist of a private wireless network and/or a neutral host network, and carries traffic generated by private and/or public subscribers. As provided by the discussion herein, accurate estimates of the performance-limiting factors (e.g., bottlenecks, for example) seen in dedicated networks provide valuable insights when purchasing or designing such a network.

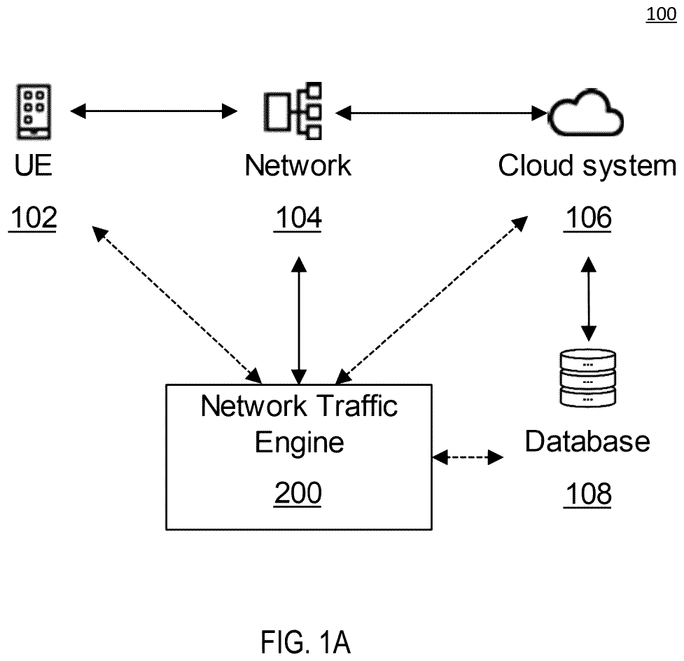

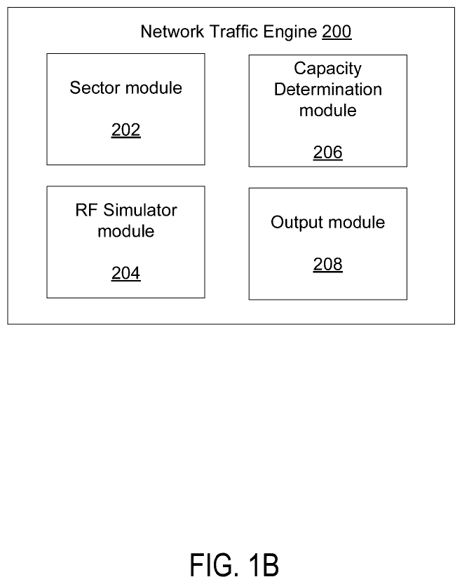

With reference to FIG. 1A, system 100 is depicted which includes user equipment (UE) 102, network 104, cloud system 106, database 108, and network traffic engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1A.

According to some embodiments, UE 102 can be any type of end-device operated in a mobile wireless network. For example, UE 102 can include, but not be limited to, a mobile phone, tablet, laptop, Internet of Things (IoT) device, wearable device, an autonomous guided vehicle (AGV), autonomous mobile robot (AMR), unmanned aerial vehicle (UAV), and/or any other device equipped with a cellular or wireless transceiver.

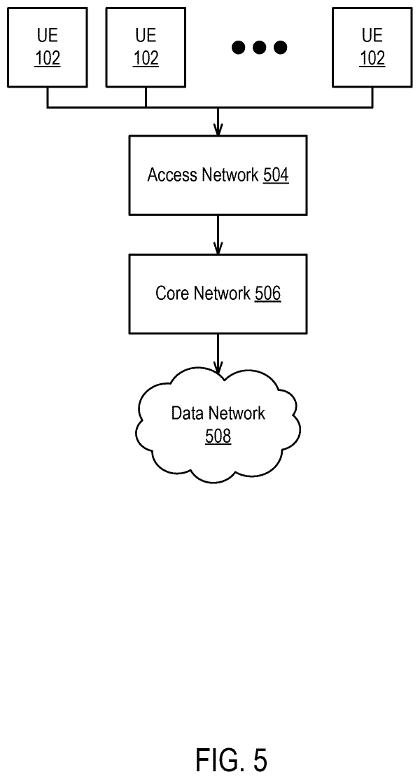

In some embodiments, network 104 can be any type of network, such as, but not limited to, a wireless network, cellular network (e.g., an LTE/5G NSA and/or a 5G SA network), and the like. Network 104 facilitates connectivity of the components of system 100, as illustrated in FIG. 1A. Further discussion of embodiments of network 104 are provided below with reference to FIG. 5.

According to some embodiments, cloud system 106 may be any type of cloud operating platform and/or network-based system upon which applications, operations, and/or other forms of network resources may be located. For example, cloud system 106 may be a service provider and/or network provider from where services and/or applications may be accessed, sourced or executed from. For example, system 106 can represent the cloud-based infrastructure associated with an MNO or the tenant of a dedicated network (e.g., network 104), and communicates with associated network resources hosted in a private or neutral host network (e.g., network 104).

In some embodiments, cloud system 106 may include a server(s) and/or a database of information. In some embodiments, a database 108 of cloud system 106 may store a set of data and/or metadata associated with network information related to the components and/or the users (e.g., UEs 102) of system 100. In addition, database 108 may store information (e.g., metadata/templates based on BBU and private core specifications) used by a network traffic engine 200, which corresponds to the novel functionality described herein.

In some embodiments, cloud system 106 can provide a private/proprietary management platform for network 104 and other devices/platforms operating thereon, and further host and/or communicate with network traffic engine 200.

According to some embodiments, database 108 may correspond to a data storage for a platform (e.g., a network hosted platform, such as cloud system 106) or a plurality of platforms. Database 108 may receive storage instructions/requests from, for example, network traffic engine 200 (and associated microservices), which may be in any type of known or to be known format, such as, for example, standard query language (SQL). Database 108 may correspond to any type of known or to be known storage, for example, a memory or memory stack of a device, a distributed ledger of a distributed network (e.g., blockchain, for example), a look-up table (LUT), and/or any other type of secure data repository.

Network traffic engine 200, as discussed above and further below in more detail, can include components for the disclosed functionality. According to some embodiments, network traffic engine 200 may be a special-purpose machine or processor within cloud system 106, or hosted by a device (or component) on network 104. In some embodiments, network traffic engine 200 may be hosted by a server and/or set of servers associated with cloud system 106.

According to some embodiments, network traffic engine 200 may be configured to implement and/or control a plurality of services and/or microservices, where each of the plurality of services/microservices are configured to execute a plurality of workflows associated with performing the disclosed estimation of backhaul bandwidth and private core capacity. Non-limiting embodiments of such workflows are provided below.

According to some embodiments, network traffic engine 200 may function as an application provided by and/or hosted by cloud system 106. In some embodiments, network traffic engine 200 may function as an application installed on a server(s), network location and/or other type of network resource associated with cloud system 106 and/or network 104. In some embodiments, network traffic engine 200 may be configured and/or installed as an augmenting script, program or application (e.g., a plug-in or extension) to another application or program provided by cloud system 106 and/or network 104.

As illustrated in FIG. 1B, according to some embodiments, network traffic engine 200 includes a sector module 202, RF simulator module 204, capacity determination module 206 and output module 208. It should be understood that the modules discussed herein are non-exhaustive, as additional or fewer modules (or sub-modules) may be applicable to the embodiments of the systems and methods discussed. More detail of the operations, configurations and functionalities of network traffic engine 200 and each of its modules, and their role within embodiments of the present disclosure will be discussed below.

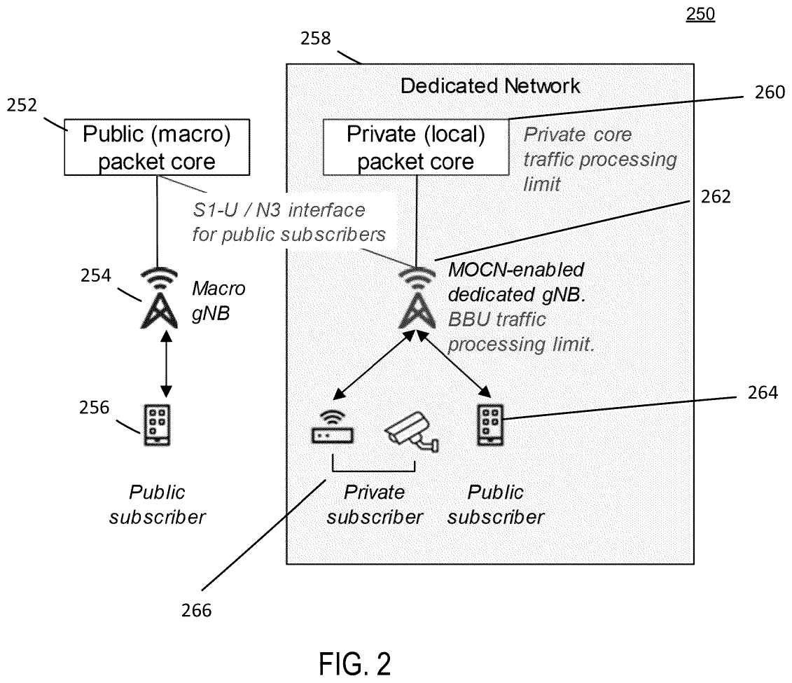

In FIG. 2, depicted is an example network environment for implementing the disclosed systems and methods. As depicted in example 250, included are public (macro) packet core 252, macro gNodeB 254, public subscriber UE 256, dedicated network 258, private (local) packet core 260, MOCN-enabled dedicated gNodeB 262, public subscriber 264 and private subscriber UE 266.

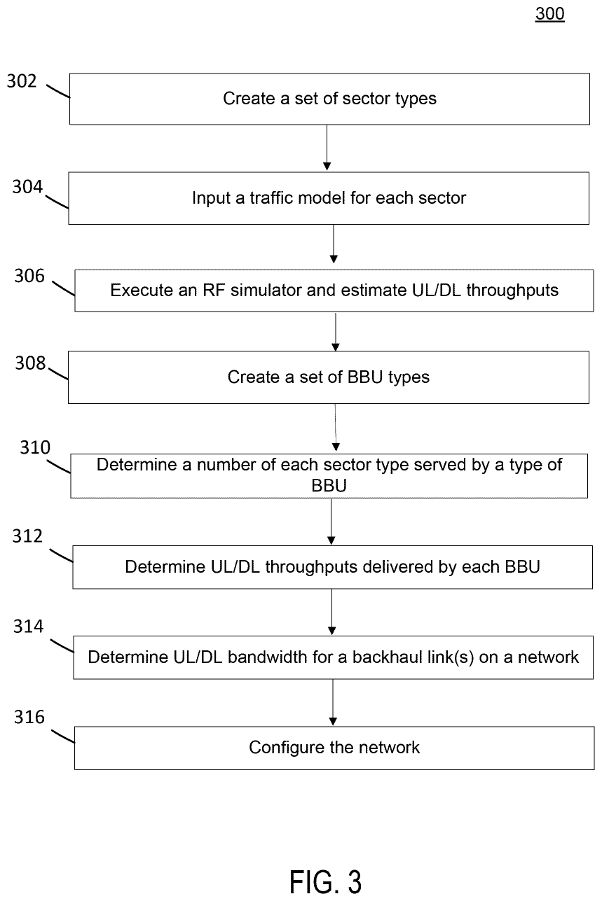

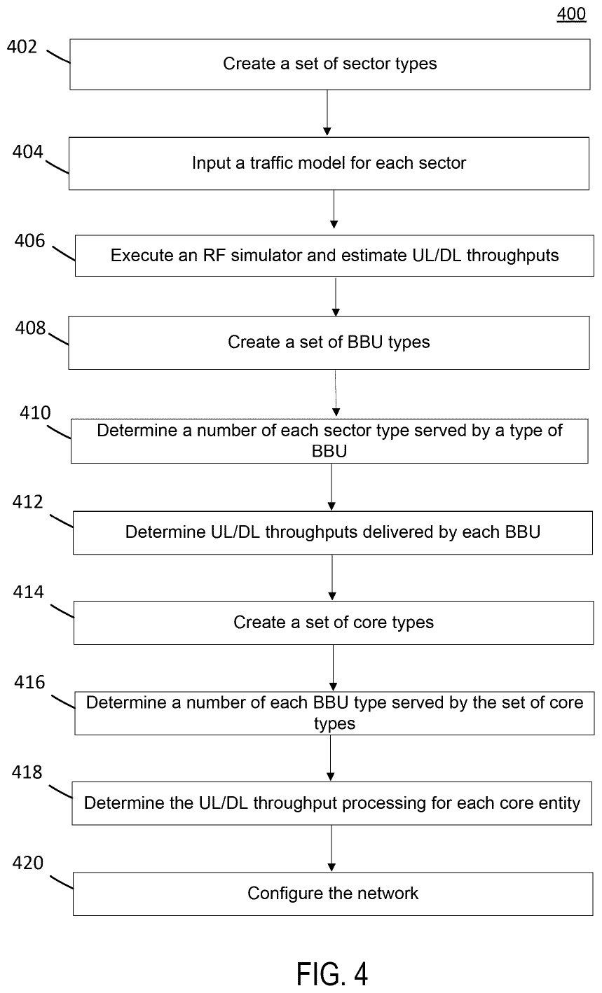

According to some embodiments, as discussed in more detail below in relation to FIGS. 3 and 4 and Processes 300 and 400, respectively, the estimation of the backhaul bandwidth (S1-U/N3 interface) can be generally applicable to the generated traffic via public subscriber devices 264, which can occur between the dedicated network 258 and public (e.g., macro) packet core 252. In some embodiments, as also discussed below, the estimation of a core capacity can be applicable to the generated traffic via private subscriber UEs 266, which, in some embodiments, can be routed to a private (e.g., local or on-site) packet core 260. In some embodiments, as discussed below, the computation of such estimates and requirements for enabling traffic via such networks (e.g., backhaul bandwidth and core capacity determinations) can be based on an estimation of the baseband unit(s) (BBU(s)) aggregate throughput.

In FIG. 3, Process 300 provides non-limiting example embodiments for determining backhaul bandwidths for a dedicated network (e.g., with public subscribers).

According to some embodiments, Steps 302, 304 and 308 of Process 300 can be performed by sector module 202 of network traffic engine 200; Step 306 can be performed by RF simulator module 204; Steps 310-314 can be performed by capacity determination module 206; and Step 316 can be performed by output module 208.

According to some embodiments, Process 300 begins with Step 302 where a set of sector types can be created. In some embodiments, a type of sectors can correspond to components and/or characteristics of a base station's (e.g., gNodeB, eNodeB, and the like) sector, which can include, but are not limited to, the model and configuration of a radio module (“radio”; also referred to as RU in 5G NR terminology) (e.g., cellular technology such as LTE or NR, maximum transmit power, receiver sensitivity, number of transmit/receive antenna elements, supported frequency band(s) and bandwidths, information related to number of carriers and carrier signals, and the like), the RF profile of a sector (e.g., statistical distribution of downlink reference signal received power (DL RSRP) and/or downlink signal-to-interference-plus-noise ratio (DL SINR), and the like.

In some embodiments, the set of sector types can include a single sector type, or a plurality of sector types. Sector types can be created, deleted and/or modified by a user. In some embodiments, each sector is defined by a number of link budget (LB) and physical layer (PHY) parameters, a RF profile and a traffic model The PHY parameters include some of the aforementioned radio module characteristics, with additional attributes including, NR numerology, duplex mode (FDD or TDD), TDD slot pattern, maximum UL and DL modulation, maximum number of UL and DL MIMO layers, the UE maximum transmit power, and the like.

In some embodiments, a “Sector Type” can be selected from a drop-down list with makes/models of eNodeB/gNodeB radio modules with a set of configuration variants for each type of radio. In some embodiments, selecting a pre-defined sector type in this manner allows for conveniently pre-populating LB and PHY parameter values which are fetched from database 108; entry of such values can be provided upfront or updated after being pre-populated.

In some embodiments, an RF profile can be input as a cumulative distribution function of the DL RSRP and/or the DL SINR, which could be based on RF measurements at the targeted network location (e.g., from a walk test or an RF planning tool). An interference model parameter is further entered to facilitate the mapping of DL RSRP to pass loss and UL SINR. In some embodiments, respective to identifying the RF distribution and interference model, an “Environment Type” can be selected from a drop-down list of typical environments seen in dedicated networks (e.g., “outdoor ports”, “indoor offices”, and the like) can be performed. In some embodiments, selecting an environment type in this manner allows for conveniently pre-populating RF profile parameter values which are fetched from database 108.

In Step 304, a traffic model can be input for each sector type (of the set of sector types from Step 302). That is, in some embodiments, for each sector type, a network traffic model can be input, which can include, but is not limited to, a type or types of UE, a type or types of application, target UL/DL data rates for each UE and/or application, a number of UEs and/or applications, and the like. In some embodiments, each sector type can be input as a column under a matrix-shaped user interface (UI).

In Step 306, engine 200 can execute an RF simulator, which upon its analysis of the aforementioned LB, PHY and traffic model parameters, outputs an estimate for UL/DL throughputs on a per sector type-basis. In some embodiments, aside from the effective sector-delivered UL and DL throughputs, the RF simulator may output some other useful information such as the maximum or theoretical sector throughputs (under high traffic load), per-UE average throughput, radio block (RB) utilization, etc. As discussed herein, an RF simulator is a computerized and executable tool used in the design and analysis of wireless communication systems and other RF-based technologies. RF simulators can be either software-based or hardware devices that enable modeling, analysis and/or prediction of the behavior of RF systems and components without the need for physical prototyping. For example, RF simulators can be utilized in creating virtual models of RF systems, including transmitters, receivers, antennas and propagation environments. RF simulators can be of a type that includes, but is not limited to, circuit level, system level, channel level, spectrum level, network level, behavior level, and the like, or some combination thereof (e.g., co-simulators, for example). Specifically for the solution being disclosed (i.e., network traffic engine 200), RF simulator module 204 has a fast response time (e.g., under a few seconds), due to a need to potentially compute sector throughputs for multiple sector types, and to run the process multiple times with slightly different input parameter values as part of an optimization workflow.

According to some embodiments, based on the input parameters (from Steps 302-304), engine 200 can call the RF simulator for each sector type (e.g., per-sector) to determine or estimate the UL and/or DL throughput delivered by the considered sector(s) in consideration of the traffic model. In some embodiments, the determined UL/DL per-sector throughputs per Step 406 can be displayed in columns on a UI, where each column represents a sector type.

In some embodiments, such intermediate estimation of the throughputs can be stored in database 108, as discussed above.

In Step 308, a set (e.g., one or a plurality) of baseband unit (BBU; also referred to as DU and/or CU in 5G NR terminology) types can be created. Such BBU types can be based on gNodeB/eNodeB makes and models, configurations (e.g., supported cellular technologies (e.g., LTE, 5G NSA, 5G SA), frequency ranges and bands, mode of operation with for instance LTE FDD and NR C-Band channels processed on the same BBU unit), and the like.

Accordingly, in some embodiments, BBU types can be created, deleted and/or modified (e.g., add, delete or modify a row) by a user, in a similar manner as the creation, deletion and modification of sector types in Step 302. Each BBU has capacity attributes related to a product specification, including, but not limited to, a maximum number of sector-carriers, a maximum aggregate UL and DL throughputs, a maximum number of connected users, and the like, or some combination thereof. In some embodiments, respective to identifying such capacity values, a “BBU Type” can be selected from a drop-down list with makes/models of eNB/gNB BBUs, where configuration variants may further be selected.

In some embodiments, selecting a pre-defined BBU type in this manner allows for conveniently pre-populating the BBU(s) capacity values which are fetched from database 108.

In Step 310, a user can specify a number of each sector type that is served by a type of BBU. In some embodiments, each BBU type can be input as a row under a matrix-shaped UI. Such determination generally corresponds to a mapping of sectors (and/or sector types) to the set of BBUs (and/or BBU types), based on a knowledge of the actual or expected topology of the dedicated network. According to some embodiments, such mapping can involve, for each instantiated BBU (from Step 308), indicating the number of served sectors among those previously instantiated (from Step 302). The RF profile and traffic model can be part of the sectors definitions and may vary for different sectors. In some embodiments, sector types with BBU types can be correlated to ensure that they are compatible (e.g., compatible wireless/cellular technology and frequency range (e.g., 5G SA mid-band), same vendors, and the like). Accordingly, the sectors to BBUs mapping scheme in Step 310 provides high flexibility in terms of being able to define the key topology aspects of a dedicated network that impact performance.

In some embodiments, information related to the identified sector types, BBU types, and the mapping of sectors to BBUs as in Step 310 can be stored in database 108, as discussed above.

In Step 312, network traffic engine 200 can determine UL/DL throughputs delivered by each BBU. In some embodiments, such determinations involve calculating the per-BBU UL/DL throughputs based on, but not limited to, the number and types of sectors served by each BBU, and the processing limits of each BBU (e.g., maximum aggregate UL and/or DL throughput that can be processed as per product specifications) as known from Step 310. In some embodiments, engine 200 can cause a notification or “warning” message to be compiled and generated for display on a device (on a user interface (UI), as discussed below) when a BBU processing limit (e.g., max. aggregate UL throughput) is reached or exceeded.

Accordingly, in some embodiments, the per-BBU UL/DL throughputs determination in Step 312 can be based on, but not limited to, the sectors definitions, the association of sectors with BBUs, and the BBUs definitions (e.g., processing limits). Engine 200 can calculate the UL and DL throughputs delivered by each BBU by performing a summation operation of the UL and DL throughputs (which, in some embodiments, can be separately performed for uplink and downlink) delivered by (all or at least a threshold portion of) the sectors served by a given BBU, and applying maximums (“caps”) based on predefined (e.g., known) processing limits for the considered BBU type/configuration.

In some embodiments, information related to the determined per-BBU UL/DL throughputs can be stored in database 108, as discussed above.

In Step 314, engine 200 can then determine a UL/DL bandwidth(s) for a backhaul link(s) on a network (e.g., wireless/cellular network, as discussed herein). According to some embodiments, Step 314 involves calculating the required UL and DL backhaul bandwidths (e.g., throughputs) on the S1-U interface (LTE/5G NSA) and/or the N3 interface (5G SA) between the dedicated network's BBUs and the public packet core. Engine 200 functions by summing up the UL and DL throughputs (in some embodiments, separately for uplink and downlink) delivered by (all or at least a threshold portion of) the BBUs. In some embodiments, such calculation can be based on a protocol (or assumption/rule) for which a single aggregation point to the S1-U or N3 interface, such as a cell site router, is utilized. In some embodiments, the backhaul bandwidth calculation can involve applying a set of adjustment factors that account Radio Link Control (RLC) layer and/or Packet Data Convergence Protocol (PDCP) overheads on the radio interface, as well as transport overheads on the S1-U/N3 interface. In some embodiments, adjustment factors may be included to adjust for base station inefficiencies from different vendors.

For example, values related to PDCP, RLC and MAC overheads can be subtracted from the per-BBU throughput values, whereas values related to transport overheads can be added to the per-BBU throughput values, as shown in the following example equation.

$$Req . Backhaul Bandwidth = ( 1 - OverheadPdcpRlcMac ) \times ( 1 + OverheadTransport ) \times {\sum }_{RBUs} BBU Proc . Load ( public subs . )$$

where OverheadPdcpRlcMac is the aggregate overhead ratio of PDCP, RLC and MAC protocol layers on the radio interface (e.g. 7% or 0.07) and OverheadTransport is the aggregate ratio of Transport protocol layers on the S1-U/N3 interface such as IPsec (e.g. 10% or 0.1), and BBU Proc. Load(public subs.) is the BBU Processing Load incurred from public subscribers.

In some embodiments, when a compilation (or mix) of public and private subscribers are operating on, connected to and/or requesting access to a dedicated network, engine 200 can operate by identifying a portion of the BBU throughput determined to be generated by public subscribers, for the purpose of backhaul bandwidth calculations. This is based on an understanding that only public subscribers need access to the public (macro) packet core, via an S1-U/N3 link with non-negligible distance and cost. Private subscribers on the other hand can access the private core (e.g., a local or on-site core), via a very short S1-U/N3 link with negligible cost.

In some embodiments, information related to the determined UL/DL bandwidths (for each backhaul link) can be stored in database 108, as discussed above.

And, in Step 316, engine 200 can function (or perform operations) to automatically configure and/or curate the dedicated network's elements and topologies based on the determined UL/DL bandwidth for the backhaul link(s) toward the public packet core, as in Step 314. In some embodiments, for example, a dedicated network can be configured by implementing traffic shaping and Quality of Service (QoS) policies to allocate and prioritize backhaul resources effectively. This can involve, for example, using advanced routing protocols and implementing packet classification to ensure critical data receives priority treatment according to the determined UL/DL backhaul bandwidths.

In some embodiments, information related to such network configuration for the dedicated network can be stored in database 108, as discussed above. In some embodiments, this can be leveraged for subsequent similar type networks (e.g., similar type and size of dedicated network) to improve the efficiency in which a network can be configured and/or curated when similar UL/DL backhaul bandwidth values (e.g., UL/DL bandwidths within a threshold range of the previously determined UL/DL bandwidths) are identified/determined.

Turning to FIG. 4, Process 400 provides non-limiting example embodiments for determining a private core capacity for a dedicated network (e.g., with private subscribers). The capacity may refer to e.g., the maximum aggregate UL and/or DL throughput that can be processed by the P-GW (LTE/5G NSA) or UPF (5G SA) gateways in the private packet core as per product specifications.

According to some embodiments, Steps 402, 404, 408 and 414 of Process 400 can be performed by sector module 202 of network traffic engine 200; Step 406 can be performed by RF simulator module 204; Steps 410, 412, 416 and 418 can be performed by capacity determination module 206; and Step 420 can be performed by output module 208.

According to some embodiments, Steps 402-412 of Process 400 are performed in a similar manner as corresponding Steps 302-312 of Process 300. Thus, at the conclusion of Step 412, engine 200 has determined the UL/DL throughputs delivered by each defined BBU entity, which has taken in account the processing limits of each BBU, in a similar manner as discussed above respective to Step 312.

In Step 414, engine 200 can operate to create a set of core types (e.g., a single private core or a plurality of private cores, e.g., a local or on-site core), which correlate with infrastructure of the dedicated network to provide high-speed, reliable and secure connectivity to private subscribers across different parts of the network. According to some embodiments, the core types can be based on core makes and models (e.g., input or identified from a predetermined drop-down list), and can include configuration information (e.g., EPC and 5GC are handled by a common server, for example). In some embodiments, such core types can be created, deleted and/or modified (e.g., add, delete or modify a row) by a user.

In some embodiments, each private core has capacity attributes related to a product specification, including, but not limited to: a maximum aggregate UL and DL throughputs, and a maximum number of connected users. In some embodiments, for example, for a single-location dedicated private network, a maximum of one EPC and one 5GC core or one dual-mode core (e.g., EPC and 5GC on a common server) can be utilized/selected.

In some embodiments, information related to the core types can be stored in database 108, as discussed above.

In Step 416, a number of each BBU type that is served by each created core entity (from Step 414) can be identified (or specified or determined, in some embodiments). In some embodiments, this can involve performing mapping operations between the BBUs (and/or BBU types) to each of the created private cores (and/or core types). Such mapping can be performed in a similar manner as discussed above respective to Step 310. In some embodiments, each private core type can be input as a row while BBU types can be laid out in columns under a matrix-shaped UI.

In some embodiments, information related to the identified BBU types, private core types, and the mapping of BBUs to cores can be stored in database 108, as discussed above.

In Step 418, engine 200 can determine the UL/DL throughput processing required for each core entity. In other words, engine 200 can calculate the required UL and/or DL private core processing capacities (e.g., throughputs).

In some embodiments, engine 200 can perform Step 418 by performing a summation operation based on the UL and DL throughputs (in some embodiments, separately for uplink and downlink) delivered by (all or at least a threshold amount of) the BBUs served by a particular private core. Such operation can involve applying maximums (“caps”) based on predefined (e.g., known) processing limits for the considered core type/configuration. In some embodiments, to derive the core throughput, values related to PDCP, RLC and MAC overheads can be subtracted from the per-BBU throughput values, as shown in the following example equation.

$$Req . Core Proc . Capacity = ( 1 - OverheadPdcpRlcMac ) \times {\sum }_{RBUs} BBU Proc . Load ( private subs . )$$

where BBU Proc. Load(private subs.) is the BBU Processing Load incurred from private subscribers.

In some embodiments, engine 200 can cause a notification or “warning” message to be compiled and generated for display on a device (e.g., within a UI, as discussed below) when a core processing limit (e.g., max. aggregate UL throughput) is reached or exceeded.

In some embodiments, when a compilation (or mix) of public and private subscribers are operating on, connected to and/or requesting access to a dedicated network, engine 200 can operate by identifying a portion of the BBU throughput determined to be generated by private subscribers, for the purpose of private core processing capacity calculations.

In some embodiments, information related to the determined UL/DL throughputs can be stored in database 108, as discussed above.

And, in Step 420, engine 200 can function (or perform operations) to automatically configure and/or curate the dedicated network's elements and topologies based on the determined UL/DL throughputs for the private core(s). According to some embodiments, such configurations can be performed in a similar manner as discussed above respective to Step 316.

In some embodiments, information related to such network configuration for the dedicated network can be stored in database 108, as discussed above. In some embodiments, this can be leveraged for subsequent similar type networks (e.g., similar type and size of dedicated network) to improve the efficiency in which a network can be configured and/or curated when similar UL/DL core throughput values (e.g., UL/DL throughput within a threshold range of the previously determined UL/DL throughput) are identified/determined.

According to some embodiments, as discussed above in relation to Processes 300 and 400 of FIGS. 3 and 4, respectively, a special user interface (e.g., an administrator UI) can be utilized to manage and/or control the configurations and/or components available for selection by regular users, such as from drop-down lists. Such admin users can create/edit/delete templates available for regular users input so as to make the overall input process more intuitive and resilient to input errors especially for non-expert users. In addition, the administrator UI also allows for setting the values of otherwise non-exposed parameters used in determinations and/or calculations such as certain adjustment factors.

FIG. 5 is a block diagram of an example network architecture according to some embodiments of the present disclosure. In the illustrated embodiment, UE 102 accesses a data network 508 via an access network 504 and a core network 506.

In the illustrated embodiment, the access network 504 comprises a network allowing network communication with UE 102. In general, the access network 504 includes at least one base station that is communicatively coupled to the core network 506 and coupled to zero or more UE 102.

In some embodiments, the access network 504 comprises a cellular access network, for example, a 5G network. In an embodiment, the access network 504 can include a NextGen Radio Access Network (NG-RAN). In an embodiment, the access network 504 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 506 and to external network-attached elements in a data network 508 such as the Internet.

In the illustrated embodiment, the access network 504 and the core network 506 are operated by a NO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 102 can connect to this network similar to connecting to a national or regional network.

In some embodiments, the access network 504, core network 506 and data network 508 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

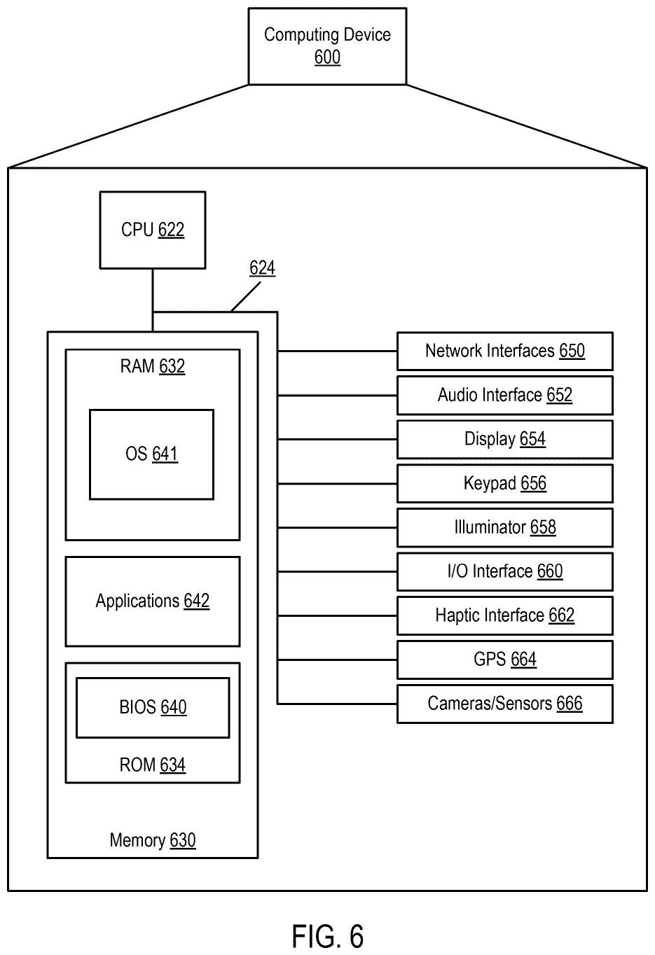

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a CPU 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to ROM 634.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special-purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
creating, in association with a network, a set of sector types, each sector type comprising information related to components and characteristics of the network;
inputting, for each of the sector types, a network traffic model comprising information related to user equipment (UE) and applications operating on the network;
executing, based on the set of sector types and the network traffic model, a Radio Frequency (RF) simulator to estimate uplink (UL) and downlink (DL) throughputs delivered by each of the set of sector types;
creating, in association with the network, a set of baseband unit (BBU) types, wherein each BBU type is suited to serve a set of sector types;
determining a number of each sector type served by each BBU in the set of BBUs;
determining uplink (UL) and downlink (DL) throughputs delivered by each BBU in the set of BBUs based on the determined number of each sector type associated with the particular BBU; and
configuring the network based on the determined UL and DL throughputs.

2. The method of claim 1, further comprising:
determining UL and DL bandwidths for a backhaul link on the network based on the UL and DL throughputs delivered by each BBU in the set of BBUs; and
performing the configuration of the network based on the UL and DL backhaul bandwidths.

3. The method of claim 1, further comprising:
creating a set of core types for the network; and
determining a number of each BBU type served by each core in the set of cores.

4. The method of claim 3, further comprising:
determining, based on the number of each BBU type served by each core in the set of cores, UL and DL throughputs for each core; and
performing the configuration of the network based on the UL and DL throughputs for each core in the set of cores.

5. The method of claim 1, wherein the network traffic model information comprises UL and DL data rates input for the UEs and applications.

6. The method of claim 1, further comprising an RF simulator that is executed for each sector type in accordance with the network traffic model.

7. The method of claim 1, further comprising the network being a network selected from a group consisting of: a public network, a private network, and a mix of public and private networks.

8. The method of claim 7, wherein the mix of public and private networks is enabled via Radio Access Network (RAN) sharing.

9. A system comprising:
a processor configured to:
create, in association with a network, a set of sector types, each sector type comprising information related to components and characteristics of the network;
input, for each of the sector types, a network traffic model comprising information related to user equipment (UE) and applications operating on the network;
execute, based on the set of sector types and the network traffic model, a Radio Frequency (RF) simulator to estimate uplink (UL) and downlink (DL) throughputs delivered by each of the set of sector types;
create, in association with the network, a set of baseband unit (BBU) types, wherein each BBU is suited to serve a set of sector types;
determine a number of each sector type served by each BBU in the set of BBUs;
determine uplink (UL) and downlink (DL) throughputs delivered by each BBU in the set of BBUs based on the determined number of each sector type associated with the particular BBU; and
configure the network based on the determined UL and DL throughputs.

10. The system of claim 9, wherein the processor is further configured to:
determine UL and DL bandwidth for a backhaul link on the network based on the UL and DL throughputs delivered by each BBU in the set of BBUs; and
perform the configuration of the network based on the UL and DL backhaul bandwidths.

11. The system of claim 9, wherein the processor is further configured to:
create a set of core types for the network;
determine a number of each BBU type served by each core in the set of cores;
determine, based on the number of each BBU type served by each core in the set of cores, UL and DL throughputs for each core in the set of core types; and
perform the configuration of the network based on the UL and DL throughputs for each core in the set of cores.

12. The system of claim 9, wherein the processor is further configured such that the network traffic model comprises UL and DL data rates input for the UEs and applications.

13. The system of claim 9, wherein the processor is further configured such that an RF simulator is executed for each sector type in accordance with the network traffic model.

14. The system of claim 9, wherein the processor is further configured such that the network is selected from a group of networks consisting of: a public network, a private network, and a mix of public and private networks.

15. The system of claim 14, wherein the mix of public and private networks is enabled via Radio Access Network (RAN) sharing.

16. A non-transitory computer-readable storage medium tangibly encoded with computer-executable instructions, that when executed by a processor, perform a method comprising:
creating, in association with a network, a set of sector types, each sector type comprising information related to components and characteristics of the network;
inputting, for each of the sector types, a network traffic model comprising information related to user equipment (UE) and applications operating on the network;
executing, based on the set of sector types and the network traffic model, a Radio Frequency (RF) simulator to estimate uplink (UL) and downlink (DL) throughputs delivered by each of the set of sector types;
creating, in association with the network, a set of baseband unit (BBU) types, wherein each BBU type is suited to serve a set of sector types;
determining a number of each sector type served by each BBU in the set of BBUs;
determining uplink (UL) and downlink (DL) throughputs delivered by each BBU in the set of BBUs based on the determined number of each sector type associated with the particular BBU; and
configuring the network based on the determined UL and DL throughputs.

17. The non-transitory computer-readable storage medium of claim 16, further comprising:
determining UL and DL bandwidths for a backhaul link on the network based on the UL and DL throughputs delivered by each BBU in the set of BBUs; and
performing the configuration of the network based on the UL and DL backhaul bandwidths.

18. The non-transitory computer-readable storage medium of claim 16, further comprising:
creating a set of core types for the network;
determining a number of each BBU type served by each core in the set of cores;
determining, based on the number of each BBU type served by each core in the set of cores, UL and DL throughputs for each core; and
performing the configuration of the network based on the UL and DL throughputs for each core in the set of cores.

19. The non-transitory computer-readable storage medium of claim 16, wherein the network traffic model information comprises UL and DL data rates input for the UEs and applications.

20. The non-transitory computer-readable storage medium of claim 16, further comprising an RF simulator that is executed for each sector type in accordance with the network traffic model.
